(19) United States
(12) Patent Application Publication
(10) Pub. No.: US 2007/0232233 A1
(43) Pub. Date: Oct. 4, 2007

(54) WIRELESS HANDSET WITH BLUETOOTH REMOTE CONTROL AND DIALING FUNCTIONALITY ON VOIP SOFTWARE APPLICATION, AND CORRESPONDING WEB PHONE

(76) Inventors: Liang-Yi Liu, Taipei City (TW); Chun-Hsin Liu, Taipei County (TW); Shih-Wei Fang, Taipei County (TW); Kuo-Ching Chang, Taipei County (TW); Yu-Chang Hung, Taipei County (TW); Chung-Peng Tsai, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/551,238

(22) Filed: Oct. 20, 2006

(30) Foreign Application Priority Data
Mar. 31, 2006 (TW) 095205502

(51) Int. Cl. H04B 7/00; H04M 1/00

(52) U.S. Cl. 455/41.2; 455/552.1; 455/556.1

(57) ABSTRACT

A wireless handset includes: a Bluetooth RF module for performing wireless communication with a Voice over Internet Protocol (VoIP) communication device having Bluetooth communication functionality; a processing circuit, coupled to the Bluetooth RF module, for remotely controlling a VoIP software application, which is embedded in the VoIP communication device, through the Bluetooth RF module according to Bluetooth Human Interface Device specifications; and an audio input/output module, coupled to the processing circuit, for receiving audio waves to input an audio signal into the processing circuit, and/or outputting audio waves; wherein the wireless handset provides web phone communication functionality by utilizing the VoIP software application.

### BACKGROUND OF THE INVENTION

1. Field of the Invention

The present invention relates to web phones, and more particularly, to wireless handsets with Bluetooth remote control and dialing functionality on a Voice over Internet Protocol (VoIP) software application, and corresponding web phones.

2. Description of the Prior Art

As Voice over Internet Protocol (VoIP) technologies progress, a real time communication software application utilizing the VoIP technologies (for example, Skype, MSN Messenger, “Yahoo! Messenger with Voice”, . . . , etc.) and various web phone accessories for personal computers (PCs) have become popular, where the real time communication software application can be simply referred to as the VoIP software application hereafter. In contrast to conventional telecommunication system, the web phones may utilize the network resources that users have on hand to provide the oral communication function as well, so communication related fees can be greatly saved. When two VoIP software application users utilize the network resources and the VoIP software application in existence to communicate, both of the two users need not pay any communication related fee.

Before a user utilizes the VoIP software application together with a certain web phone accessory on the market, for example, a Universal Serial Bus (USB) handset, to communicate with somebody, it is typically required to install a driver corresponding to the web phone accessory in a PC, causing communication inability of those who are not familiar to driver installation before getting help from others. Even the user is familiar with driver installation, it still wastes the user's time and further occupies system resources of the PC to install the driver. In addition, if the user wants to utilize the VoIP software application together with another PC to communicate with somebody, it further wastes the user's time to install the driver in the other PC.

### SUMMARY OF THE INVENTION

It is an objective of the claimed invention to provide wireless handsets with Bluetooth remote control and dialing functionality on a Voice over Internet Protocol (VoIP) software application and corresponding web phones to solve the above-mentioned problem.

It is another objective of the claimed invention to provide wireless handsets with Bluetooth remote control and dialing functionality on a VoIP software application and corresponding web phones to reduce accessory wiring around personal computers (PCs).

According to one embodiment of the claimed invention, a wireless handset is disclosed. The wireless handset comprises: a Bluetooth RF module for performing wireless communication with a VoIP communication device having Bluetooth communication functionality; a processing circuit, coupled to the Bluetooth RF module, for remotely controlling a VoIP software application, which is embedded in the VoIP communication device, through the Bluetooth RF module according to Bluetooth Human Interface Device specifications; and an audio input/output module, coupled to the processing circuit, for receiving audio waves to input an audio signal into the processing circuit, and/or outputting audio waves; wherein the wireless handset provides web phone communication functionality by utilizing the VoIP software application.

While the wireless handset mentioned above is provided, a web phone is provided correspondingly. The web phone comprises: a VoIP communication device having Bluetooth communication functionality, where a VoIP software application is embedded in the VoIP communication device; and a wireless handset. The wireless handset comprises: a Bluetooth RF module for performing wireless communication with the VoIP communication device; a processing circuit, coupled to the Bluetooth RF module, for remotely controlling the VoIP software application through the Bluetooth RF module according to Bluetooth Human Interface Device specifications; and an audio input/output module, coupled to the processing circuit, for receiving audio waves to input an audio signal into the processing circuit, and/or outputting audio waves; wherein the wireless handset provides web phone communication functionality by utilizing the VoIP software application.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless handset according to one embodiment of the present invention.

FIG. 2 illustrates the wireless handset shown in FIG. 1, where the wireless handset provides web phone communication functionality by utilizing a Voice over Internet Protocol (VoIP) software application.

FIG. 3 is a block diagram of the wireless handset shown in FIG. 1.

### DETAILED DESCRIPTION

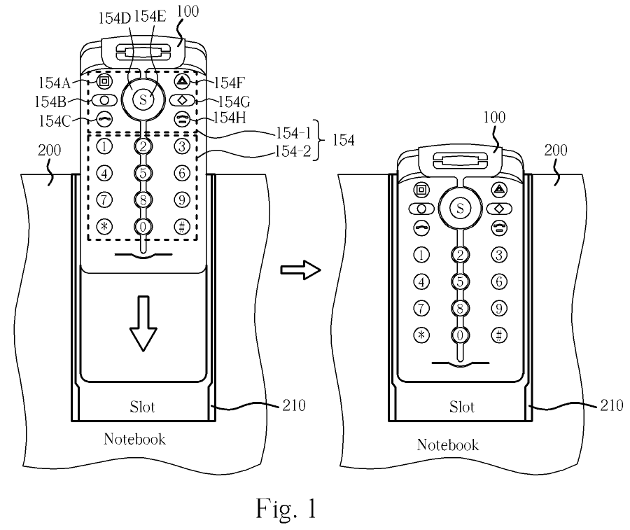

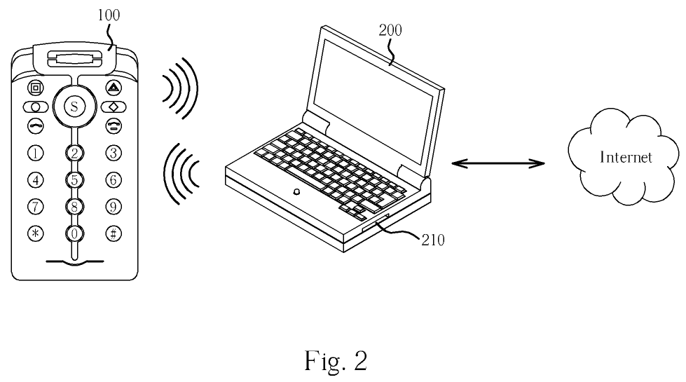

Please refer to FIG. 1 and FIG. 2. FIG. 1 is a diagram of a wireless handset 100 according to one embodiment of the present invention, and FIG. 2 illustrates the wireless handset 100 shown in FIG. 1, where the wireless handset 100 provides web phone communication functionality by utilizing a Voice over Internet Protocol (VoIP) software application (for example, Skype, MSN Messenger, “Yahoo! Messenger with Voice”, . . . , etc.). The VoIP software application is embedded in a VoIP communication device such as a web phone main device or a personal computer (PC). According to one embodiment of the present invention, the VoIP communication device is a web phone main device, for example, a Broadband VoIP Adaptor (BVA). Therefore, the wireless handset 100 and the BVA form a telephone, and more particularly, a web phone. In addition, According to the embodiment shown in FIG. 1 and FIG. 2, the VoIP communication device is a PC, for example, the notebook 200, and the VoIP software application is installed in the notebook 200. Therefore, the wireless handset 100 and the notebook 200 form a telephone, and more particularly, a web phone.

As shown in FIG. 1, the wireless handset 100 of this embodiment can be stored in a slot 210 of the notebook 200, for example, a PCMCIA slot, so that a user may carry the notebook 200 together with the wireless handset 100. Regarding old-fashioned notebooks, PCMCIA slots are typically utilized for expanding peripheral devices or accessories (e.g. network interface card). However, the PCMCIA slots are seldom utilized since most of the peripheral devices or accessories mentioned above are integrated into the notebooks of the day. Therefore, it is practicable to store the wireless handset 100 in one of the PCMCIA slots of the notebook 200. According to this embodiment, when the wireless handset 100 is stored in the slot 210 of the notebook 200, it is not necessary to electrically connect the wireless handset 100 to any terminal in the slot 210.

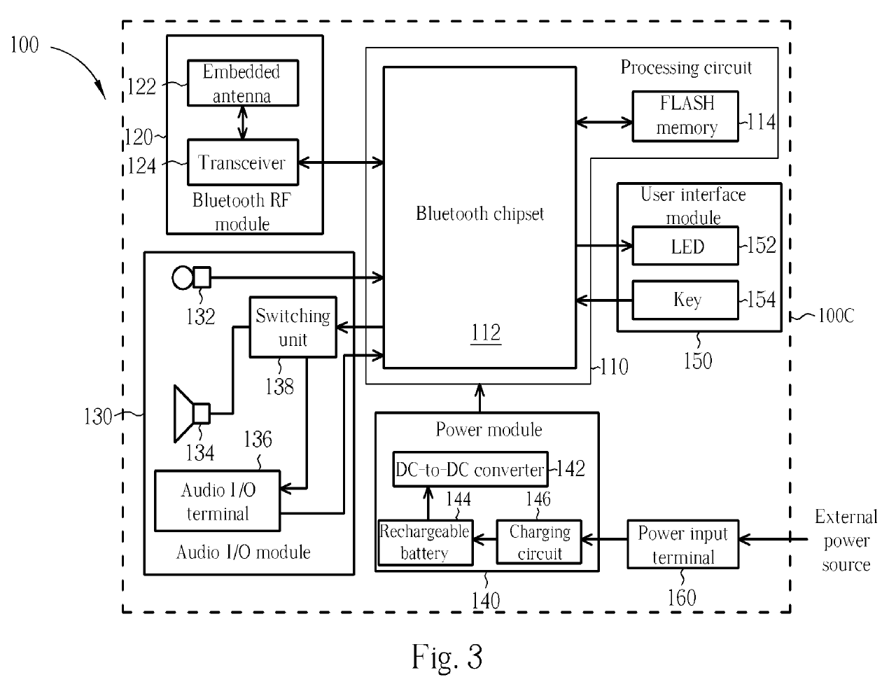

Please refer to FIG. 3. FIG. 3 is a block diagram of the wireless handset 100 shown in FIG. 1. As shown in FIG. 3, the wireless handset 100 comprises a processing circuit 110, a Bluetooth RF module 120, an audio input/output (I/O) module 130, a power module 140, a user interface module 150, and power input terminals 160, where the components mentioned above are installed in/on a printed circuit board (PCB) 100C of the wireless handset 100. The processing circuit 110 comprises a Bluetooth chipset 112 and a storage unit such as a FLASH memory 114. In addition, the Bluetooth RF module 120 comprises an embedded antenna 122 and a transceiver 124, and the audio I/O module 130 comprises a microphone 132, a speaker 134, a plurality of audio I/O terminals 136, and a switching unit 138. Additionally, the power module 140 comprises a DC-to-DC converter 142, a battery, and a charging circuit 146, where the battery is a rechargeable battery 144 in this embodiment. The user interface module 150 comprises Light Emitting Diodes (LED) 152 and a plurality of keys 154, where the keys 154 comprise a plurality of function keys 154-1 and a dialing keypad 154-2, and the dialing keypad 154-2 comprises digit keys from 0 to 9 and a star key and further a harsh key, as shown in FIG. 1.

The notebook 200 mentioned above has Bluetooth communication functionality. The wireless handset 100 performs wireless communication with the notebook 200 by utilizing the Bluetooth RF module 120, and further provides web phone communication functionality by utilizing the VoIP software application, where the embedded antenna 122 is utilized for receiving or transmitting electromagnetic waves, and the transceiver 124 is utilized for performing signal conversion. Within the audio I/O module 130, the microphone 1 32 is utilized for receiving audio waves to generate an audio signal and inputting the audio signal into the processing circuit 110, the speaker 134 is utilized for outputting audio waves, and the audio I/O terminals 136 comprise an stereo earphone terminal for coupling an earphone and a headset terminal for coupling a headset, where the switching unit 138 performs signal switching when the stereo earphone terminal is coupled to the earphone or the headset terminal is coupled to the headset. According to this embodiment, the rechargeable battery 144 is coupled to at least one of the other components within the power module 140 through a plurality of power terminals (not shown), so the user may replace the rechargeable battery 144 when needed. In addition, the charging circuit 146 can be coupled to an external power source through the power input terminals 160 to store electric power provided by the external power source into the rechargeable battery 144, where the external power source can be an AC-to-DC converter or another kind of power source. Additionally, the DC-to-DC converter 142 is utilized for converting a voltage of the rechargeable battery 144 for utilization by the processing circuit 110. The Bluetooth RF module 120, the audio I/O module 130, and the power module 140 mentioned above are well known in the art, and therefore not explained in detail here.

According to some embodiments of the present invention, the processing circuit 110 may trigger at least one key of the notebook 200 through the Bluetooth RF module 120 according to Bluetooth Human Interface Device specifications to remotely control the VoIP software application. More particularly, the at least one key of the notebook 200 comprises at least one hot key of the notebook 200. In addition, the Bluetooth chipset 112 provides control complying with the Bluetooth Human Interface Device specifications. The FLASH memory 114 mentioned above stores a program code, which is a firmware code in the embodiment shown in FIG. 1. According to the control of the firmware code, the processing circuit 110 may trigger the keys of the notebook 200, and more particularly, the hot keys of the notebook 200, in order to control the VoIP software application, where the hot keys are respectively defined in a hot key setting menu provided by the VoIP software application. For example, the VoIP software application is Skype. Within the hot key setting menu of the VoIP software application, the user may respectively set hot keys “Alt-PgUp” and “Alt-PgDn” as functions of “Answering a call” (which is typically referred to as “Off-hook”) and “Hanging up a call” (which is typically referred to as “On-hook”) in advance, where the wireless handset 100 is capable of providing function settings corresponding to the hot keys mentioned above, so the function keys 154B and 154H are respectively set as the functions of “Answering a call” and “Hanging up a call”. As a result, when a specific function key of the function keys 154-1 is pressed, the processing circuit 110 triggers the hot key corresponding to the specific function key through the Bluetooth RF module 120 to control a specific function of the VoIP software application. As the present invention utilizes the Bluetooth Human Interface Device specifications as the corresponding means between the function keys 154-1 of the wireless handset 100 and the keys of the notebook 200 (the hot keys of the notebook 200, especially), the user may utilize the web phone function provided by the wireless handset 100 without further installing any driver in the notebook 200. In addition, when the user wants to utilize the VoIP software application together with another PC to communicate with somebody, as long as the other PC has Bluetooth communication functionality, the user may also utilize the web phone function provided by the wireless handset 100 without further installing any driver in the other PC.

In this embodiment, the user may respectively set the function keys 154A, 154B, 154C, 154F, and 154H as the functions of “Muting during a call”, “Answering a call”, “Making a call”, “Mute on/off-switching”, and “Hanging up a call”, where the default settings of the function keys 154E and 154G are functions of “Window switching” and “Cursor switching” (i.e. Tab) in the operating system (OS). The user may alter the settings of the function keys 154E and 154G to set them as the functions corresponding to certain hot keys as mentioned above. In addition, the “Up”, “Down”, “Left”, and “Right” direction control keys combined within the circular function key 154D can be respectively set as functions of “Scrolling down”, “Scrolling up”, “Decreasing volume”, and “Increasing volume”. When the user wants to make a phone call to communicate with somebody having a normal telephone, the user may dial by utilizing the dialing functionality provided by the dialing keypad 154-2. For example, the VoIP software application is Skype, and when the user wants to dial a normal telephone number with the “Skype out” function thereof, the user may dial by utilizing the dialing keypad 154-2. As a result, the Bluetooth chipset 112 in the processing circuit 110 performs dialing function control on the VoIP software application through the Bluetooth RF module 120 according to dialing signals outputted by the dialing keypad 154-2 within the user interface module 150. Through controlling of the Bluetooth RF module 120 by the processing circuit 110, the wireless handset 100 and the notebook 200 may transmit audio information to each other, so under the control of the processing circuit 110, the user may communicate with other person(s) through the audio I/O module 130.

According to some embodiments of the present invention, the user may switch between different VoIP software applications by utilizing the keys within the user interface module 150 (e.g. the function key 154E), and may set the relationships between the function keys 154-1 and hot keys utilized by each VoIP software application by utilizing at least one combination of a portion of the keys within the user interface module 150 (e.g. by pressing two or more keys at the same time). According to the embodiment shown in FIG. 1, as the hot keys utilized by different VoIP software applications are different from each other, once the user switch to any of the VoIP software applications, the function represented by any function key of the function keys 154-1 can be utilized for controlling the corresponding function of the VoIP software application selected by the user without causing the user to be confused by his/her perception of the function represent by any function key and without causing the same function key to trigger different VoIP software applications.

In this embodiment, the power input terminals 160 are implemented with a Mini Universal Serial Bus (USB) port. Thus, the power module 140 may input the power provided by a USB port of the notebook 200 through the power input terminals 160, in order to charge the rechargeable battery 144. According to a variation of this embodiment, the power input terminals 160 can be terminals complying with specifications of the slot 210. Thus, the power module 140 may derive the power provided by the notebook 200 through the power input terminals 160 coupled to the slot 210, in order to charge the rechargeable battery 144.

In contrast to the prior art, before the user utilizes the wireless handset of the present invention to provide the web phone function by utilizing the VoIP software application, it is not necessary to install any driver in the PC in advance regarding the wireless handset. That is, a corresponding driver is not required for the wireless handset to operate normally.

It is another advantage of the present invention that once the user wants to utilize the VoIP software application mentioned above together with another PC to communicate with somebody, as long as the other PC has Bluetooth communication functionality, the user may also utilize the web phone function provided by the wireless handset without further installing any driver in the other PC. Therefore, the user may utilize the same wireless handset to communicate with the other persons, and may benefit by the convenience of switching between different PCs without installing any driver.

It is yet another advantage of the present invention that if the VoIP communication device of the present invention is implemented with a web phone main device such as a BVA, and if the BVA is provided with the Bluetooth communication functionality, the user may benefit by the convenience of wireless communication (e.g. no wiring around the BVA is required) and further benefit by the convenience of plug-and-play characteristics. In any place with a network communication port provided, the user may utilize the web phone provided by the present invention with the VoIP communication device coupled to the network communication port.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless handset comprising:
a Bluetooth RF module for performing wireless communication with a Voice over Internet Protocol (VoIP) communication device having Bluetooth communication functionality;
a processing circuit, coupled to the Bluetooth RF module, for remotely controlling a VoIP software application, which is embedded in the VoIP communication device, through the Bluetooth RF module according to Bluetooth Human Interface Device specifications; and
an audio input/output module, coupled to the processing circuit, for receiving audio waves to input an audio signal into the processing circuit, and/or outputting audio waves;
wherein the wireless handset provides web phone communication functionality by utilizing the VoIP software application.

2. The wireless handset of claim 1, wherein the processing circuit comprises:
a Bluetooth chipset for providing control complying with Bluetooth Human Interface Device specifications; and
a storage unit, coupled to the Bluetooth chipset, for storing a program code;
wherein the processing circuit controls the VoIP software application according to the program code.

3. The wireless handset of claim 2, wherein the storage unit is a FLASH memory, and the program code is a firmware code.

4. The wireless handset of claim 1, wherein the VoIP communication device is a web phone main device.

5. The wireless handset of claim 1, wherein the VoIP communication device is a personal computer (PC), and the VoIP software application is installed in the PC.

6. The wireless handset of claim 1, wherein the processing circuit triggers at least one key of the VoIP communication device through the Bluetooth RF module according to Bluetooth Human Interface Device specifications to remotely control the VoIP software application.

7. The wireless handset of claim 6, further comprising:
at least one function key corresponding to the at least one key of the VoIP communication device, wherein when the function key is pressed, the processing circuit triggers the at least one key of the VoIP communication device through the Bluetooth RF module to control the VoIP software application.

8. The wireless handset of claim 6, wherein the VoIP communication device is a personal computer (PC), the VoIP software application is installed in the PC, and the at least one key of the VoIP communication device comprises at least one hot key of the PC.

9. The wireless handset of claim 1, further comprising:
a dialing keypad for providing dialing functionality through the VoIP software application.

10. The wireless handset of claim 1, wherein the wireless handset comprises a power module for providing the processing circuit with power, and the power module comprises:
a rechargeable battery;
a charging circuit, coupled to the rechargeable battery, for storing electric power provided by an external power source into the rechargeable battery; and
a DC-to-DC converter, coupled to the rechargeable battery, for converting a voltage of the rechargeable battery for utilization by the processing circuit.

11. A web phone comprising:
a Voice over Internet Protocol (VoIP) communication device having Bluetooth communication functionality, a VoIP software application being embedded in the VoIP communication device; and
a wireless handset comprising:
a Bluetooth RF module for performing wireless communication with the VoIP communication device;
a processing circuit, coupled to the Bluetooth RF module, for remotely controlling the VoIP software application through the Bluetooth RF module according to Bluetooth Human Interface Device specifications; and
an audio input/output module, coupled to the processing circuit, for receiving audio waves to input an audio signal into the processing circuit, and/or outputting audio waves;
wherein the wireless handset provides web phone communication functionality by utilizing the VoIP software application.

12. The web phone of claim 11, wherein the processing circuit comprises:
a Bluetooth chipset for providing control complying with Bluetooth Human Interface Device specifications; and
a storage unit, coupled to the Bluetooth chipset, for storing a program code;
wherein the processing circuit controls the VoIP software application according to the program code.

13. The web phone of claim 12, wherein the storage unit is a FLASH memory, and the program code is a firmware code.

14. The web phone of claim 11, wherein the VoIP communication device is a web phone main device.

15. The web phone of claim 11, wherein the VoIP communication device is a personal computer (PC), and the VoIP software application is installed in the PC.

16. The web phone of claim 11, wherein the processing circuit triggers at least one key of the VoIP communication device through the Bluetooth RF module according to Bluetooth Human Interface Device specifications to remotely control the VoIP software application.

17. The web phone of claim 16, wherein the wireless handset further comprises:
at least one function key corresponding to the at least one key of the VoIP communication device, wherein when the function key is pressed, the processing circuit triggers the at least one key of the VoIP communication device through the Bluetooth RF module to control the VoIP software application.

18. The web phone of claim 16, wherein the VoIP communication device is a personal computer (PC), the VoIP software application is installed in the PC, and the at least one key of the VoIP communication device comprises at least one hot key of the PC.

19. The web phone of claim 11, wherein the wireless handset further comprises:
a dialing keypad for providing dialing functionality through the VoIP software application.

20. The web phone of claim 11, wherein the wireless handset further comprises a power module for providing the processing circuit with power, and the power module comprises:
a rechargeable battery;
a charging circuit, coupled to the rechargeable battery, for storing electric power provided by an external power source into the rechargeable battery; and
a DC-to-DC converter, coupled to the rechargeable battery, for converting a voltage of the rechargeable battery for utilization by the processing circuit.
